(19) United States
(12) Patent Application Publication
(10) Pub. No.: US 2005/0153258 A1
(43) Pub. Date: Jul. 14, 2005

(54) Endodontic gutta percha placement tool with disposable gutta percha cartridge and a motor-driven plunger arrangement

(76) Inventor: Jay McCoy, Temecula, CA (US)

Correspondence Address: Myers Dawes Andras & Sherman LLP, Suite 1150, 19900 MacArthur Blvd., Irvine, CA, 92612, US

(21) Appl. No.: 10/981,403

(22) Filed: Nov. 3, 2004

Related U.S. Application Data
(60) Provisional application No. 60/517,413, filed on Nov. 4, 2003.

(51) Int. Cl. A61C 5/02; A61C 5/04

(52) U.S. Cl. 433/81; 433/90; 433/224

(57) ABSTRACT

An electrically heated endodontic syringe for injecting thermoplastic material, such as gutta percha, into a root canal cavity including a handpiece, control box, receiver for receiving a pre-filled cartridge of a thermoplastic material, tapered needle and a foot control peddle. The cartridge is made out of a high temperature plastic material and is indirectly heated by the control box, causing the thermoplastic material inside, preferably gutta percha, to become pliable. The handpiece includes a lead screw that, when activated, slides along the length of the hand piece and contacts a cartridge plunger at an open end of the cartridge, causing the thermoplastic material to travel along a central pathway, through the needle and into the cavity. The plunger is operated by a foot peddle.

### RELATED APPLICATIONS

The present application is related to U.S. Provisional Patent Application, Ser. No. ______, filed on ______, which is incorporated herein by reference and to which priority is claimed pursuant to 35 USC 119.

### BACKGROUND OF THE INVENTION

1. Field of the Invention

The invention relates generally to the field of dental endodontics and, more particularly, to an endodontic gutta percha placement tool with a disposable gutta percha cartridge, a disposable injection needle and a motor-driven plunger arrangement.

2. Description of the Prior Art

In the field of dentistry, filling an inflamed root canal cavity is quite common. One preferred method involves cleaning out the canals and removing the diseased pulp tissue of the damaged tooth with files, drills, and burrs, all the way to the bottom or apex of the tooth. At that point, the tooth is dead. The damaged tooth, however, can be covered with a so-called crown that approximates the features and characteristics of the original tooth. Before the crown can be applied, however, the empty cavity left behind by the root canal operation must be back-filled to prevent bacteria from entering empty cavity and causing infections and to reduce problems with respect to pressure differentials.

Endodontists traditionally perform this backfill operation by packing a thermo-plastic material known as gutta percha, or GP, which is the milky juice of Malaysian trees and has a semisolid state at a normal temperature, but becomes a hard rubber-like gum when heated.

The process of filling the vacated canal traditionally begins by down packing the lower ⅓ of the canal with several long “cones” of gutta percha that are selected in size and taper on the basis of the file, drill or burr used to vacate the canal. This down packing process for the lower ⅓ of the canal is well known to those of ordinary skill in the art.

A gutta percha manual injection gun or many cones of gutta percha is generally used to fill the upper portion of the canal. A conventional gutta percha gun is a manual operated device that heats a slug of gutta percha within a heated barrel and then, using a hand-operated plunger, forces the molten gutta percha out of a needle-like tip. The foregoing device is quite similar to a hot glue gun.

There are several problems with the just described gutta percha gun. First, the gutta percha slug is in direct contact with the interior of the heated barrel and the face of the plunger that forces the gutta percha out through the needle at the front of the gun. Accordingly, the interior of the gun must be cleaned after each use. Moreover, it is sometimes necessary to replace the plunger periodically because of this direct contact. Second, the hand-operation of the gun interferes with the endodontist's ability to know that the vacated canal is full through tactile feedback while performing the fill. In particular, because the just-described gun requires the endodontist to squeeze the handle of the tool, it makes it relatively difficult to perceive the upward pressure on the needle tip caused by hydraulic back pressure caused by the gutta percha filling within the cavity.

There remains a need, therefore, for a gutta percha placement tool that improves upon the just-described device.

### BRIEF SUMMARY OF THE INVENTION

Accordingly, the present invention has been made keeping in mind the above problems occurring in the prior art and an object of the present invention Is to provide a gutta percha placement tool that solves one or more of these problems. The present invention is a gutta percha placement tool according to one embodiment of the present invention and includes a handheld tool with a heated chamber that receives a gutta percha cartridge formed from a disposable high temperature plastic cartridge containing gutta percha. For that purpose, the preferred chamber includes a side-loading port through which the gutta percha cartridge may be inserted. The preferred gutta percha cartridge includes a sealing ring (e.g. an o-ring) that engages an interior lumen leading to disposable needle tip to prevent any leakage of gutta percha into the heat chamber. A back end of the gutta percha cartridge is opened to receive a plunger that forces the molten gutta percha out of the gutta percha cartridge and into and through the needle.

As a result of the use of a gutta percha cartridge according to this embodiment of the invention, there is a significantly reduced need to clean the gutta percha placement tool, if ever.

Moreover, the preferred gutta percha placement tool of the present invention uses a lead screw that forces the melting gutta percha from the cartridge into the needle tip of the tool. As a result of this unique use of a motor-driven lead screw, the endodontist does not need to squeeze the device and, therefore, is allowed much more ability to sense the back pressure, i.e. to have the tactual feedback described above while placing the gutta percha in the canal.

The hollow needle used with the gutta percha tool is preferably made of a metal having high thermal conductivity such as a silver alloy or a copper alloy. That way, the hollow needle is sufficiently hot so that the melting gutta percha does not solidify as it is pushed through and nears the far end of the hollow needle. The preferred needle has a continuous taper, free of joints. In the preferred embodiment, a foot pedal would be used to allow the endodontist to conveniently operate the motor that drives the lead screw.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a partially see through view of a first embodiment of the present invention.

FIG. 2 is a side view of the injector element of a first embodiment of the present invention.

FIGS. 2a-2d show a more detailed view of a first embodiment of the present invention.

FIG. 3 is a partially see through view of the distal end of a first embodiment of the present invention.

FIG. 4 is a side view of the cartridge element of a first embodiment of the present invention.

FIG. 5 is an exploded side view of a second embodiment of the present invention.

FIG. 6 is a see through view of a second embodiment of the present invention.

FIG. 7 is a side view of a second embodiment of the cartridge element of the present invention.

FIG. 8 is a side view of a preferred embodiment of a needle.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

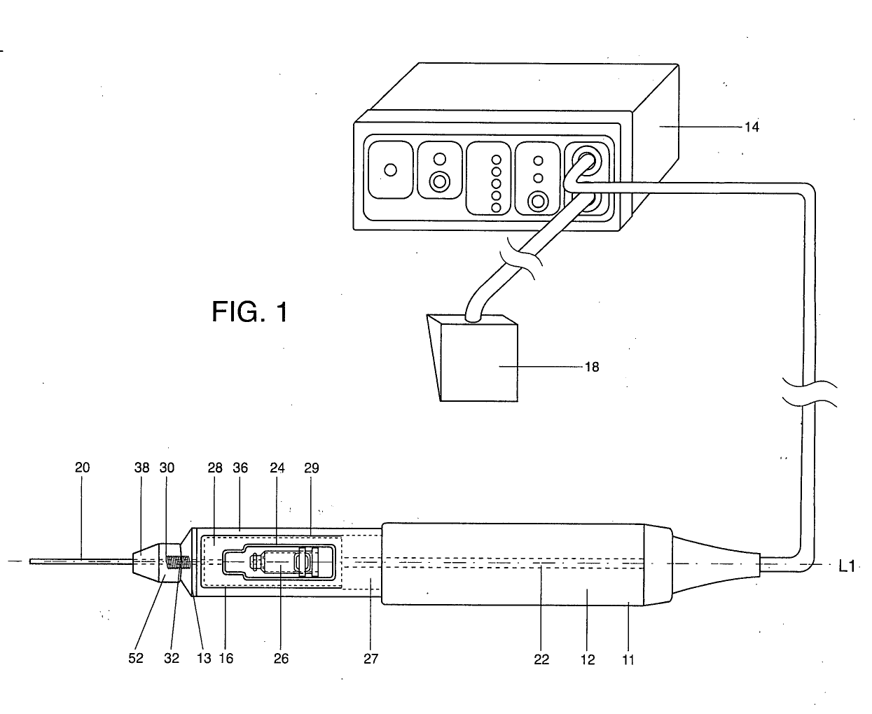

Referring initially to FIG. 1, a first preferred embodiment of an endodontic injection apparatus 10 for injecting material in to a prepared root canal according to the present invention is shown. The injection apparatus 10 comprises a handpiece 11 that is directly connected to a power control box 14. The handpiece defines a longitudinal axis L1 that extends there through from a proximal end 12 to a distal end 13 thereof. A chamber 16 is defined within the handpiece 11 and defines a hollow cavity 28 therein. In a preferred embodiment the handpiece 11 is a pen-like injector.

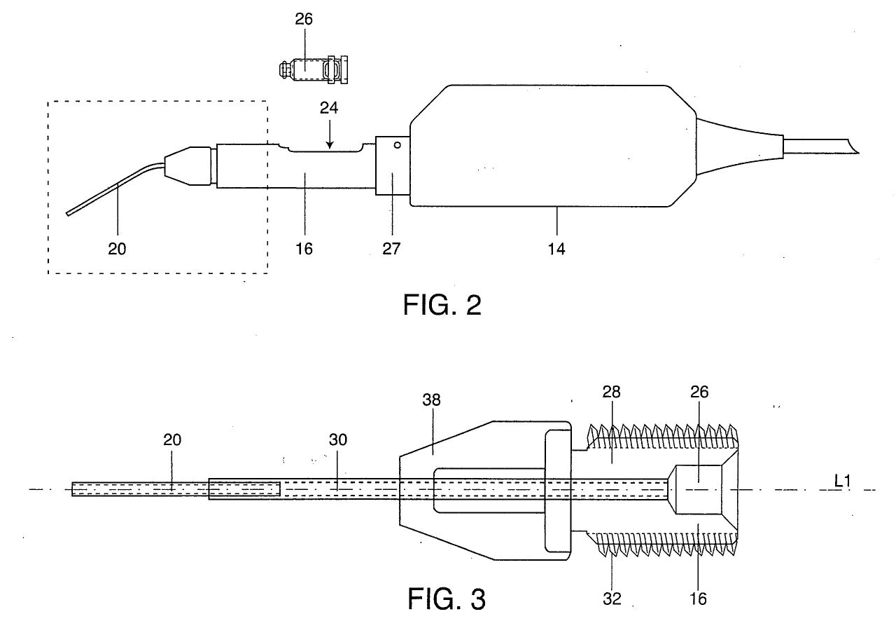

The proximal end 12 of the handpiece 10 includes a lead screw 22 that is axially aligned with the longitudinal axis L1. The lead screw 22 travels on the longitudinal axis L1 when it is actuated. In a preferred embodiment, an electrical power control box electronically actuates the lead screw 22. In another embodiment, the lead screw 22 is electronically actuated by a foot pedal. As shown best in FIGS. 1 and 2, a pre-filled cartridge 26 is loaded into the handpiece 11 via a side loading port 24 that the cartridge 26 drops into. The side loading port 24 leads to the chamber 16 within the handpiece 11 and the chamber receives the cartridge 16 when it is dropped into the side loading port 24. When the cartridge 26 is loaded into the chamber 16, and the lead screw 22 is actuated, the electrical control box 14 provides power to a heating element 29 that is disposed around the chamber 16. The chamber 16 heats up and the cartridge 26 is thereby indirectly heated causing the thermoplastic material within the cavity 44 to become pliable. This allows the thermoplastic material to travel through the needle 20 when the lead screw 22 is actuated and forces the thermoplastic material out of the cartridge opening 46. In a preferred embodiment, the cartridge is disposable and the thermoplastic material is gutta percha. FIG. 2a shows the lead screw 22 retracted so that the cartridge 26 may be loaded into the side loading port 24. FIG. 2b shows the cartridge 26 within the chamber 16.

In a preferred embodiment, an insulating sleeve 36 is removably inserted over the chamber 16 after the cartridge 26 is inserted into the side loading port 24.

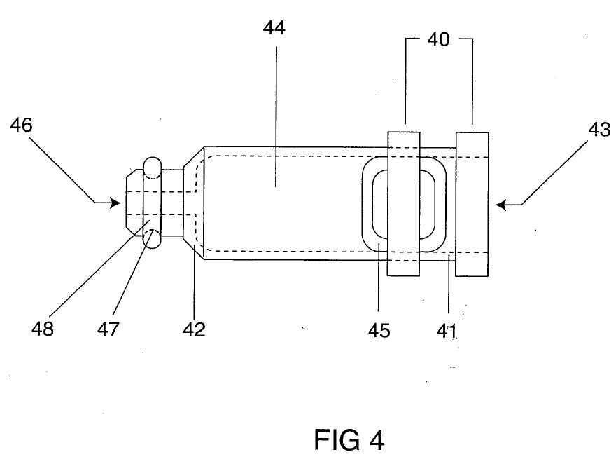

As shown best in FIG. 3, the distal end 13 of the needle nut 52 has mating threads 32 that thread into the chamber 16 and comprises a central passageway 30 that extends from the cartridge 26 to a needle 20. The needle extends through a plastic flange 38 that is connected to the needle nut 52 with threading 32 or any other fastening device that connects the needle 20 directly to the needle nut 52. In a preferred embodiment the needle is jointless and made of a high thermal conductive material i.e. a silver or copper alloy.

As is best seen in FIG. 2, the needle 20 and nut 52 assembly is separate from the cartridge 26, and therefore the needle 20 and nut 52 assembly, at the discretion of the operating endodontist, does not need to be replaced every time the cartridge 26 is emptied. This gives the endodontist the option of reusing the needle 20 and nut 52 assembly with multiple cartridges 26. The option of the needle 20 and nut 52 assembly being reusable saves the user money because otherwise he would have to constantly replace the needle 20 and nut 52 assembly and order more, and he would have to spend the time properly disposing of it and changing them.

As seen in FIG. 4, the pre-filled cartridge 26 comprises a proximal end 41 and a distal end 42 and defines a cavity 44 within. The distal end 42 of the cartridge 26 comprises grooves 47 for an O-ring to be placed in order to assure that when the thermoplastic material is discharged from the cartridge 26, it does not leak into the chamber 16. In a preferred embodiment, the thermoplastic material is gutta percha. The distal end 42 of the pre-filled cartridge 26 comprises an opening 46 for discharging the thermoplastic material that is held within the cavity 44.

In a first embodiment, the pre-filled cartridge 26 comprises at least one stop 40 that abuts against the chamber 16, and prevents the cartridge 26 from moving within the chamber 16. In a preferred emodiment, there are two adjacent stops 40 that create a space between them and allows the heated cartridge 26 to be pulled out of the chamber 16 with a tool after use. During activation, a lead screw 22 travels on the longitudinal axis L1 towards the distal end of the injection apparatus 10 and contacts a plunger 45 located within the cavity 44 causing the plunger 45 to move towards the distal end 13 of the handpiece 11. The thermoplastic material is then forced to the distal end 42 of the cartridge 26, through the opening 46 of the cartridge 26 and into a central passageway 30 that leads to the needle 20. The thermoplastic material is smoothly pushed out of the cartridge 26 in a continuous and uniform motion, causing very little movement of the injection apparatus while in the root canal. This makes it relatively easy to perceive the upward pressure on the needle tip within the cavity. In a preferred embodiment, the plunger 45 has two sealing rings that contact the walls of the cavity 44. This ensures that the gutta percha will not leak out of the cartridge 26 when the plunger 45 is sliding within the cavity 44.

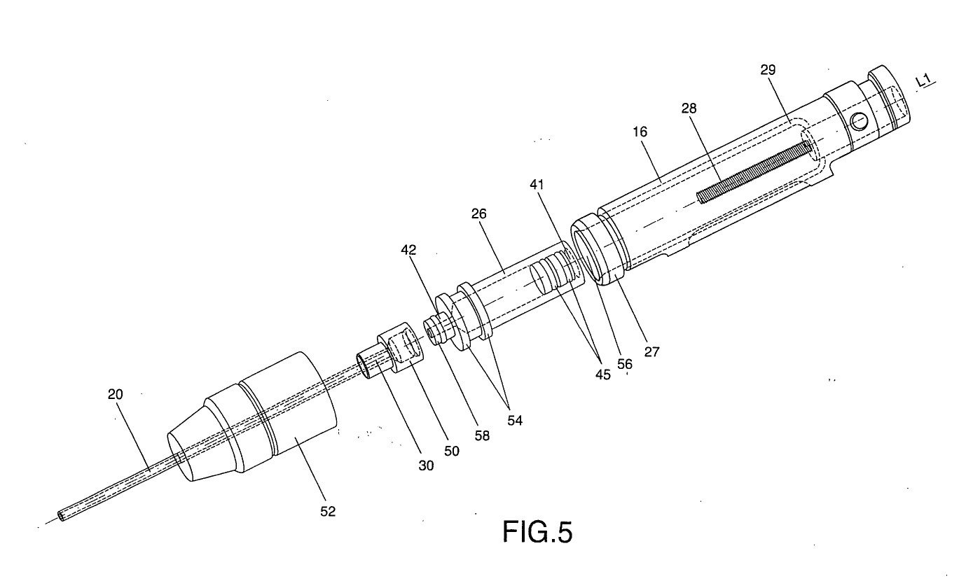

In a second embodiment, shown in FIG. 5, the pre-filled cartridge 26 is loaded into a front aperture 56 on the chamber 16 and abuts against a lead screw (not shown) that is in a fixed position. Having the lead screw be in a fixed position eliminates the loading and waiting time. Once the cartridge 26 is inserted into the front aperture 56, a needle hub 50 fits onto the nozzle 58 of the cartridge and puts the needle 20 in fluid communication with the cartridge 26 via a central passageway 30. A nut 52 is then strattled over the needle 20 and has mating threads 32 that thread onto the mating threads 27 of the chamber 16. In a preferred embodiment, the nut 52 is made out of copper, so that the heat from the heating element 29 transfers through the nut 52 and to the needle 20. In a preferred embodiment, the nut 52 is hexagonal so that a wrench can be used to tighten the nut 52 onto the chamber 16.

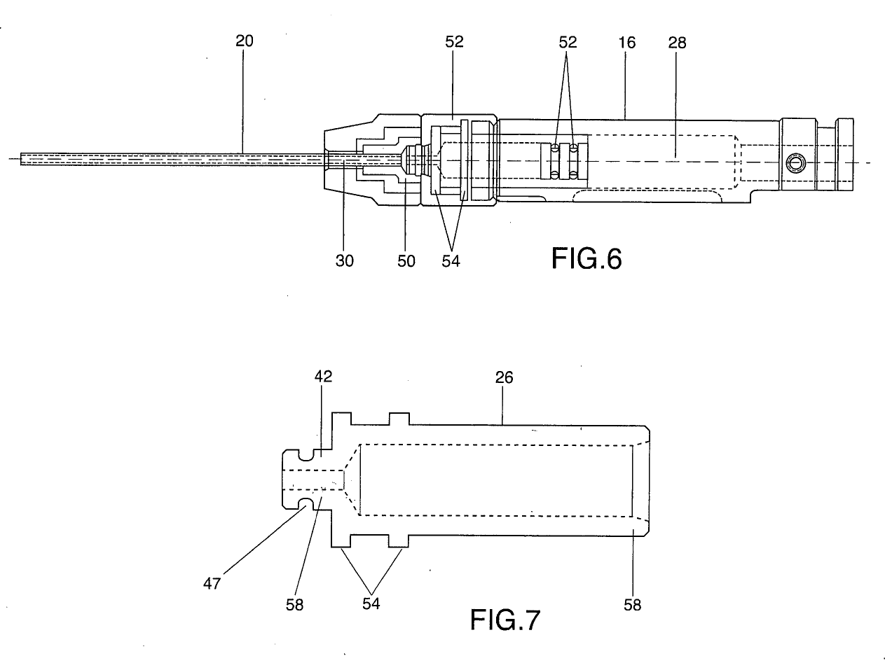

FIGS. 5 and 6 show a second embodiment of the invention assembled, wherein the cartridge 26 is front loaded into the chamber 16.

In a second embodiment, best shown in FIG. 7, the distal end 42 of the cartridge 26 comprises at least one stop 54 i.e. O-ring, that sealingly engages the interior lumen of the cartridge. In the second preferred embodiment, there are two stops 54 located on the distal end 42 of the cartridge 26. On the nozzle 58 of the cartridge 26, is a groove 47 adapted to hold a sealing ring (not shown). The proximal end 41 of the cartridge 26 is open to receive a lead screw 22.

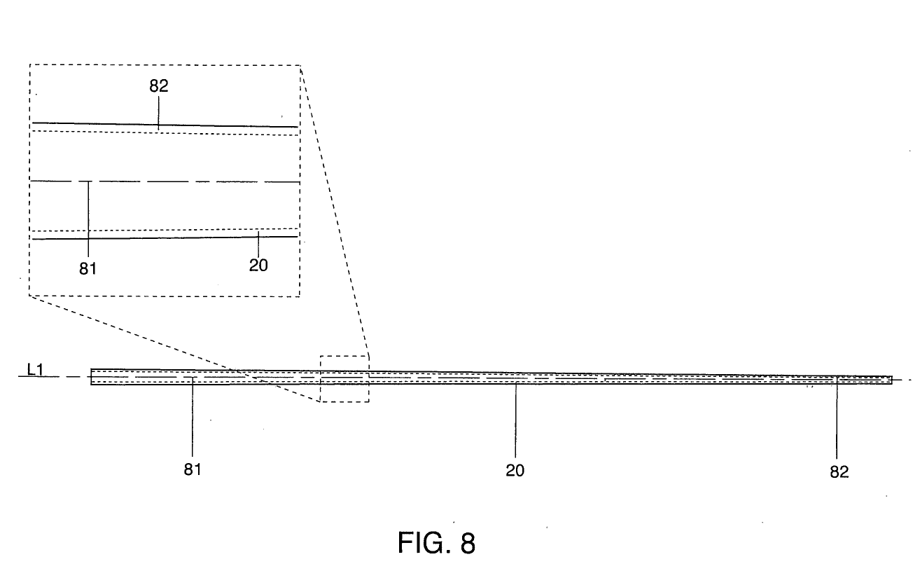

FIG. 8 shows a preferred embodiment of the needle 20 being joint free and tapered from a proximal end 81 to a distal end 82. In the preferred embodiment the needle 20 is made from a silver or copper alloy.

A root canal is back filled with a thermoplastic material by providing an endodontic injection apparatus 10 having a handpiece 11, a cylindrical chamber 16 defined within the handpiece 11, a side-loading port 24 adapted to receive a disposable cartridge 26, wherein the cartridge 26 defines a cavity 28 within, has a proximal end 41 and a distal end 42 and is pre-filled with gutta percha. A lead screw 22 aligned on a longitudinal axis L1; and a reusable needle 20 coupled to the handpiece 11, wherein the needle 20 can be reused with multiple cartridges 26. A heating element 29 directly connected to a electrical power control box 24 is supplied to heat the chamber 16. The proximal end of the cartridge 26 comprises at least one stop 40 and is open to receive a lead screw 22, and the distal end comprises a discharge aperture 46. The lead screw 22 is electronically actuated by a foot control peddle 18 and smoothly and uniformly pushes a plunger 45 located within the cavity 44 towards the distal end 13 of the handpiece 11.

Many alterations and modifications may be made by those having ordinary skill in the art without departing from the spirit and scope of the invention. For example,

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. An endodontic injection apparatus for injecting filling material in a prepared root canal, comprising:
a handpiece having a proximal end and a distal end connected to a power control box, wherein the handpiece defines a longitudinal axis;
a cylindrical chamber defined within the handpiece;
a side-loading port on the handpiece adapted to receive a disposable pre-filled cartridge, wherein the cartridge has a proximal end and a distal end and defines a cavity within;
a plunger within the cavity; and
a reusable needle, having a proximal end and a distal end, coupled to the chamber, wherein the needle can be reused with multiple cartridges.

2. The endodontic injection apparatus of claim 1, further comprising a heating element directly connected to a electrical power control box.

3. The endodontic injection apparatus of claim 1, wherein the plunger is moved towards the distal end of the handpiece by a lead screw that is electronically actuated by a foot control peddle.

4. The endodontic injection apparatus of claim 1, wherein the cartridge is pre-filled with gutta percha.

5. The endodontic injection apparatus of claim 1, wherein the cartridge includes a nozzle on its distal end having a sealing ring saddle adapted to hold a sealing ring.

6. The endodontic injection apparatus of claim 1, wherein the distal end of the pre-filled cartridge comprises an opening adapted to receive a lead screw.

7. The endodontic injection apparatus of claim 6, wherein the lead screw contacts the plunger and smoothly pushes the plunger and the gutta percha towards the distal end of the cartridge and through a discharge aperture in one continuous and uniform motion.

8. The endodontic injection apparatus of claim 1, wherein the plunger includes at least one exterior sealing member that engages an interior lumen of the cartridge.

9. The endodontic injection apparatus of claim 1, wherein the cartridge is plastic.

10. The endodontic injection apparatus of claim 1, wherein the cartridge is made from a high temperature plastic chosen from “Ultem” or polycarbonate.

11. The endodontic injection apparatus of claim 1, wherein the reusable needle is coupled to the handpiece by a needle nut assembly, the needle nut assembly including mating thread that threads into the chamber.

12. The endodontic injection apparatus of claim 1, wherein the needle further comprises a continuous taper and has a central passageway that is in fluid communication with the pre-filled cartridge, the central passageway extends through the needle along the longitudinal axis of the injection apparatus.

13. The endodontic injection apparatus of claim 1, wherein the at least one exterior stopping member is on the proximal end of the cartridge.

14. The endodontic injection apparatus of claim 1, wherein the cartridge further comprises a nozzle on the distal end that includes a sealing ring saddle adapted to hold a sealing ring.

15. A disposable cartridge for an endodontic injection apparatus, comprising;
a body with a proximal end and a distal end defining a hollow cavity that is pre-filled with a thermoplastic material, the body having at least one external stop;
a first opening on the proximal end adapted to receive a lead screw;
a plunger within the cavity; and
a second opening in the distal end of the body that is in communication with a reusable needle.

16. The disposable cartridge of claim 15, wherein the thermoplastic material is gutta percha.

17. The disposable cartridge of claim 15, wherein the cartridge is high temperature plastic.

18. The disposable cartridge of claim 15, wherein the cartridge is inserted into the endodontic injection apparatus through a side loading port of the injection apparatus.

19. The disposable cartridge of claim 15, wherein the cartridge is inserted into the endodontic injection apparatus through a front-loading port of the injection apparatus.

20. A method of back filling a root canal with a thermoplastic material, comprising the steps of:
providing an endodontic injection apparatus having a handpiece with a longitudinal axis extending there through;
a cylindrical chamber defined within the handpiece;
a port adapted to receive a disposable cartridge;
wherein the cartridge defines a cavity within, has a proximal end and a distal end and is pre-filled with gutta percha;
a plunger within the cartridge; and
a reusable needle coupled to the handpiece, wherein the needle can be reused with multiple cartridges.

21. The method of back filling a root canal of claim 20, further comprising a heating element directly connected to a electrical power control box.

22. The method of back filling a root canal of claim 20, wherein the plunger electronically actuated by a foot control peddle.

23. The method of back filling a root canal of claim 20, wherein the proximal end of the pre-filled cartridge comprises cylindrical plunger adapted to receive a lead screw, and the distal end comprises a discharge aperture, when the lead screw is activated by the foot control peddle the lead screw contacts the plunger and smoothly pushes the plunger and the gutta percha towards the distal end of the cartridge and through the discharge aperture in one continuous motion.

24. An endodontic injection apparatus for injecting filling material in a prepared root canal, comprising:
a handpiece connected to a power control box, wherein the handpiece defines a longitudinal axis;
a cylindrical chamber defined within the handpiece having a heating element;
an aperture on the handpiece adapted to receive a disposable pre-filled cartridge, wherein the cartridge has a proximal end and a distal end and defines a cavity within, the cartridge having at least one stopping member that abuts the inner walls of the chamber;
a plunger aligned on the longitudinal axis within the cartridge; and
a reusable needle, having a proximal end and a distal end, wherein the needle can be reused with multiple cartridges.

25. The endodontic injection apparatus of claim 24 further comprising a needle nut assembly that is removably coupled to the handpiece.

26. The endodontic injection apparatus of claim 24, the cartridge further comprising a nozzle having a sealing ring saddle, wherein the proximal end of the needle is coupled to a hub that fits over a nozzle, forming a central lumen between the cartridge and the needle.

27. The endodontic injection apparatus of claim 24, further comprising a removable nut that transfers heat from the heating element to the needle.

28. The endodontic injection apparatus of claim 24, wherein the at least one exterior stopping member is on the distal end of the cartridge.
